(19) United States
(12) Patent Application Publication
(10) Pub. No.: US 2017/0358954 A1
(43) Pub. Date: Dec. 14, 2017

(54) CONVERTER

(71) Applicant: PowerbyProxi Limited, Freemans Bay, Auckland (NZ)

(72) Inventor: Saining REN, Freemans Bay, Auckland (NZ)

(73) Assignee: PowerbyProxi Limited, Freemans Bay, Auckland (NZ)

(21) Appl. No.: 15/521,084

(22) PCT Filed: Oct. 21, 2015
(86) PCT No.: PCT/NZ2015/050175

§ 371 Date: Apr. 21, 2017

Related U.S. Application Data
(60) Provisional application No. 62/067,108, filed on Oct. 22, 2014.

(51) Int. Cl. H02J 50/12; H02M 3/335; H02M 7/217; H02M 7/219; H02M 7/5387

(52) U.S. Cl. CPC H02J 50/12; H02M 3/33592; H02M 7/217; H02M 2007/53878; H02M 2007/2195

(57) ABSTRACT

An inductive power receiver 3 including at least two switches S₁, S₂ connected across a resonant circuit 802, the resonant circuit including an inductance and a capacitance, wherein a first switch S₁ of the at least two switches is configured to switch into a first state based on a first event dependent on a receiver variable; and the first switch is configured to switch to a second state based on a second event independent of a receiver variable.

### FIELD OF THE INVENTION

This invention relates generally to a converter particularly, but not exclusively, to a converter for an inductive power transfer system.

### BACKGROUND OF THE INVENTION

Electrical converters are well known in the art and are available in many configurations for a variety of applications. Generally speaking, a converter converts an electrical supply of one type to an output of a different type. Such conversion can include DC-DC, AC-AC and DC-AC electrical conversions. In some configurations a converter may have any number of DC and AC ‘parts’, for example a DC-DC converter might incorporate an AC-AC transformer converter section.

More specifically, ‘inverter’ is a term that can be used to describe a DC-AC converter. An inverter may exist in isolation or as part of a larger converter (as in the above example, which must invert the DC to AC prior to the AC-AC transformer). Therefore, ‘converter’ should be interpreted to encompass inverters themselves and converters that include inverters. For the sake of clarity, the remainder of this specification will refer only to ‘converter’ without excluding the possibility that ‘inverter’ might be a suitable alternative term in certain contexts.

There are many configurations of converters that achieve DC-AC conversion. Predominately, this is through a suitable arrangement of switches that by means of co-ordinated switching cause current to flow in alternating directions through a component. The switches can be controlled by control circuitry to achieve a desired AC output waveform.

Further circuit components can be included to shape the output waveform. Subject to the particular circuit topology, the output waveform will be dependent on the switches' frequencies, duty-cycles and working interrelationship.

One example of the use of converters is in the context of inductive power transfer (IPT) systems. These systems are a well known area of established technology (for example, wireless charging of electric toothbrushes) and developing technology (for example, wireless charging of handheld devices on a ‘charging mat’). Typically, a primary side generates a time-varying magnetic field from a transmitting coil or coils. This magnetic field induces an alternating current in a suitable receiving coil that can then be used to charge a battery, or power a device or other load. In some instances, it is possible to add capacitors around the transmitter coil to create a resonant circuit. Similarly, capacitors can be added around the receiver coil(s) to create a resonant circuit. Using a resonant circuit can increase power throughput and efficiency at the corresponding resonant frequency.

Ordinarily, the transmitting coils are driven by a converter. The characteristics of the driving current (such as frequency, phase and magnitude) will be related to the particular IPT system. In some instances, it may be desirable for the driving frequency of the converter to match the resonant frequency of the resonant transmitting coil and/or the resonant receiving coil. The magnitude may be changed to correspond to the load requirements on the secondary side. In some systems, the load requirements can be communicated to the primary side by a suitable means.

All of these layers of control add complexity and cost to the design of IPT systems. Accordingly, it is desired to have a simplified method of controlling a converter.

Another problem associated with IPT systems, is that for resonant systems, the resonant frequency of the transmitter is not fixed but varies according to the load on the receiver. Changes in the load are reflected back to the transmitter through the mutual inductive coupling, which in turns affects the resonant frequency of the transmitter. Thus, if the converter is supplying an output to the transmitter coil at a frequency that is no longer equivalent to the resonant frequency of the transmitter the power throughput is diminished and the system becomes less efficient.

A further problem associated with IPT systems is that the values of resonant components such as the transmitter or receiver coil and the resonant capacitors may vary due to manufacturing tolerances, age, temperature, power transmission distance changes and the presence of nearby metal or magnetic material, among other factors. These variations affect the resonant frequency of the transmitter, which may fall out of resonance with the receiver causing power throughput to be diminished and the system to become less efficient.

One way that this variation in resonant frequency can be accommodated is by adapting the control switches to switch off and switch on when the voltage through the transmitting coil goes to zero. Thus, the switching frequency will automatically correspond to the resonant frequency of the transmitting coil. A disadvantage of such a solution is that the frequency of the transmitted magnetic field will then vary over a range dependent on the resonant frequency of the transmitting coil. This is problematic for two reasons: first, the receiver must adaptively retune to changes in the transmitted frequency or alternatively lose power; and secondly, it is undesirable to have the system operating over a range of frequencies since the available bandwidth might be too narrow.

It is an object of the invention to provide the public with a useful choice.

### SUMMARY OF THE INVENTION

According to one example embodiment there is provided an inductive power receiver including at least two switches connected across a resonant circuit, the resonant circuit including an inductance and a capacitance, wherein:
a first switch of the at least two switches is configured to switch into a first state based on a first event dependent on a receiver variable; and
the first switch is configured to switch to a second state based on a second event independent of a receiver variable.

It is acknowledged that the terms “comprise”, “comprises” and “comprising” may, under varying jurisdictions, be attributed with either an exclusive or an inclusive meaning. For the purpose of this specification, and unless otherwise noted, these terms are intended to have an inclusive meaning—i.e. they will be taken to mean an inclusion of the listed components which the use directly references, and possibly also of other non-specified components or elements.

Reference to any prior art in this specification does not constitute an admission that such prior art forms part of the common general knowledge.

### BRIEF DESCRIPTION OF THE DRAWINGS

The accompanying drawings which are incorporated in and constitute part of the specification, illustrate embodiments of the invention and, together with the general description of the invention given above, and the detailed description of embodiments given below, serve to explain the principles of the invention.

FIG. 1 is a schematic diagram of an inductive power transfer system;

FIG. 2 is a circuit diagram of a converter topology according to an embodiment;

FIG. 3 is a series of graphs relating to typical control of a converter;

FIG. 4 is a series of graphs relating to control of a converter according to an embodiment;

FIG. 5 is a series of graphs relating to control of a converter according to a further embodiment;

FIG. 6 shows waveforms relating to control of a converter according to another embodiment;

FIG. 7 shows a converter topology according to another embodiment;

FIG. 8 is a circuit diagram of a receiver configuration with a split receiver coil L1 and L2;

FIG. 9 is a series of graphs showing how varying a delay pulse results in varying of the DC output;

FIG. 10 is a circuit diagram of a controller embodiment of the receiver configuration of FIG. 8; and

FIG. 11 is a circuit diagram of a receiver configuration with a separate receiver coil L5.

### DETAILED DESCRIPTION OF EMBODIMENTS OF THE INVENTION

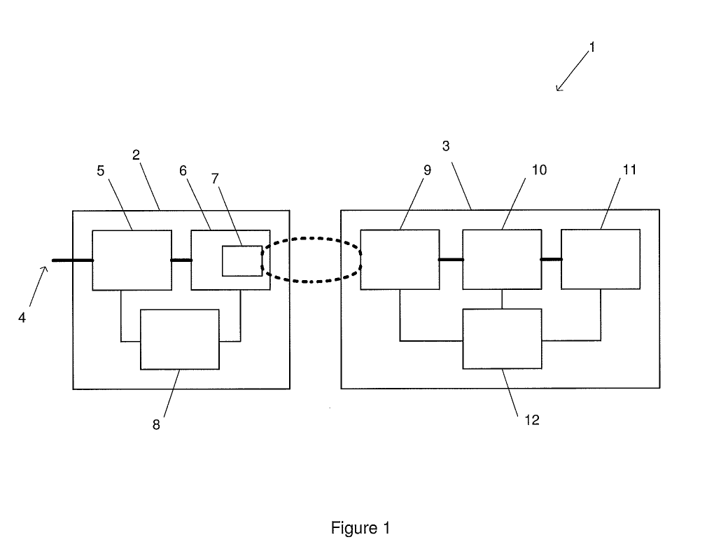

An inductive power transfer (IPT) system 1 is shown generally in FIG. 1. The IPT system includes an inductive power transmitter 2 and an inductive power receiver 3. The inductive power transmitter is connected to an appropriate power supply 4 (such as mains power). The inductive power transmitter may include an AC-DC converter 5 that is connected to an inverter 6. The inverter supplies a transmitting coil or coils 7 with an AC current so that the transmitting coil or coils generate an alternating magnetic field. In some configurations, the transmitting coils may also be considered to be separate from the inverter. The transmitting coil or coils may be connected to capacitors (not shown) either in parallel or series to create a resonant circuit.

FIG. 1 also shows a controller 8 within the inductive power transmitter 2. The controller may be connected to each part of the inductive power transmitter. The controller may be adapted to receive inputs from each part of the inductive power transmitter and produce outputs that control the operation of each part. The controller may be implemented as a single unit or separate units, adapted to control various aspects of the inductive power transmitter depending on its capabilities, including for example: power flow, tuning, selectively energising transmitting coils, inductive power receiver detection and/or communications.

The inductive power receiver 3 includes a receiving coil or coils 9 that is connected to receiving circuitry 10 that in turn supplies power to a load 11. When the inductive power transmitter 2 and inductive power receiver are suitably coupled, the alternating magnetic field generated by the transmitting coil or coils 7 induces an alternating current in the receiving coil or coils 9. The receiving circuitry 10 is configured to convert the induced current into a form that is appropriate for the load 11. The receiving coil or coils 9 may be connected to capacitors (not shown) either in parallel or series to create a resonant circuit. In some inductive power receivers, the receiver may include a controller 12 which may control the tuning of the receiving coil or coils 9, or the power supplied to the load 11 by the receiving circuitry 10.

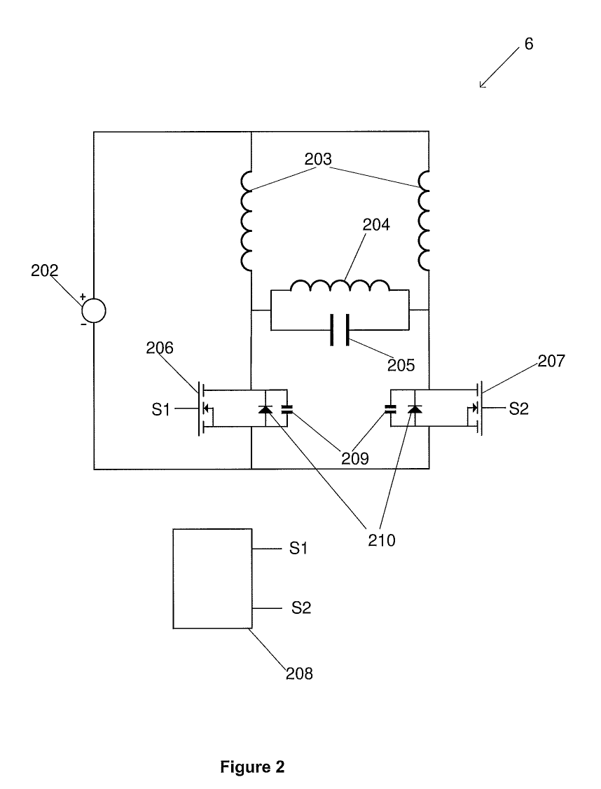

FIG. 2 shows an example of the inverter 6. The inverter 6 includes a DC supply 202, DC inductors 203, an output inductor 204 (transmitting coil 7), resonant capacitor 205, control switches (which for the sake of clarity shall be called switch one 206 and switch two 207) and control circuitry 208. Also shown in FIG. 2 are parasitic capacitors 209 and parasitic body diodes 210, which are characteristic of the control switches.

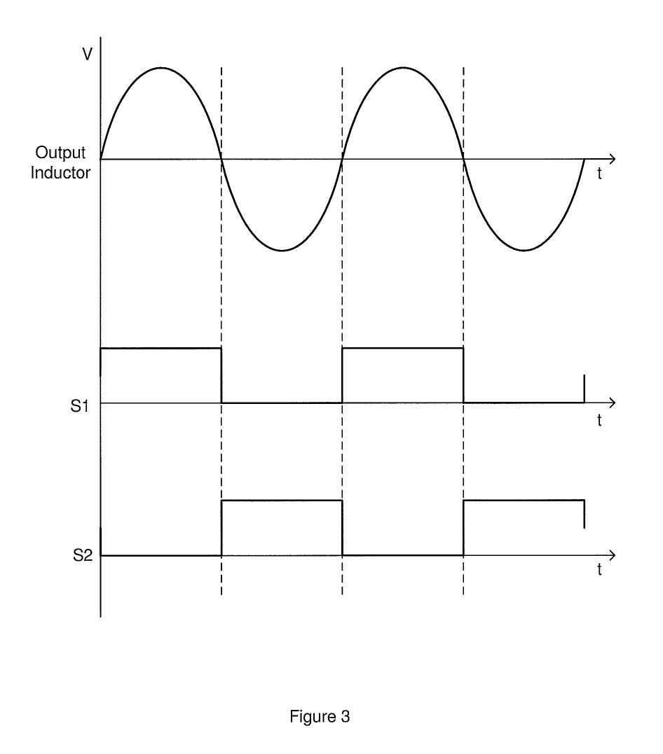

Under typical operation of the inverter 6 switch one 206 and switch two 207 are alternately switched on and off with a 50% duty cycle. The frequency of the switches is such as to match the natural resonant frequency of the output inductor 204 and resonant capacitor 205. This will produce the waveforms as shown in FIG. 3. To achieve the switching pattern, prior systems might employ a controller that is programmed to activate the switches alternately according to the zero crossings of the output inductor voltage.

A method of controlling the converter may be as follows: each switch is switched into a first state at the occurrence of a first switching event dependent on a converter variable; and switched into a second state at the occurrence of a second switching event independent of a converter variable.

The following will refer to the first state as an on state, and the second state as an off state. However, the first state may also be an off state and the second state may also be an on state.

### First Switching Event

The first switching event is when the voltage across switch one 206 or switch two 207 goes to, or near to, zero. That is to say, the switch one switches on when the voltage across switch one goes to, or near to, zero and switch two switches on when the voltage across the switch two goes to, or near to, zero. Since the voltage across switch one 6 or switch two 207 is dependent on the voltage across the output inductor 4, it can be said to be related to a dependent variable of the converter. In this way, the switches switching on can accommodate changes in the system since the occurrence of the first switching event may alter with changes in the system.

In this way the first event is dependent on a converter variable; the converter variable being the voltage zero crossing.

The voltage can be detected and when it reaches a certain value it becomes a triggering event. For example, a comparator circuit may output a change in state when a voltage across the resonant transmitter coil falls below a defined threshold. This control can be contained in the control circuitry 208.

One benefit of using the voltage across switch one 206 or switch two 207 reaching or nearing zero as the first switching event may be zero-voltage switching. That is to say, the switches are switched on when the voltage across them is zero, which minimises energy losses, improves efficiency and prevents damage to the switches due to overcurrent.

In another embodiment, the first switching event is the zero crossing of the current through switch one or switch two. That is to say, switch one switches on when the current through switch one goes to, or near to, zero and switch two switches on when the current through switch two goes to, or near to, zero. Other variable characteristics in the system 1 may be suitable as the basis for a first switching event.

### Second Switching Event

The second switching event is the expiration of a fixed time interval (α) after the other switch has switched off. That is to say, switch one 206 is switched off a fixed time interval (α) after switch two has switched off and switch two 207 is switched off a fixed time interval (α) after switch one has switched off. Since the switching off of switch one or switch two is not related to a dependent variable of the system (i.e. it is preset and will not vary), it will stay the same regardless of any changes in the system. Further, since the switches are continuously switching off after a fixed time interval, the frequency of the switches is also not related to a dependent variable of the system. The frequency of the converter can be calculated according to equation 1

$${f}_{converter} = \frac{1}{2 α} \qquad ( 1 )$$

A circuit may be included to detect a switch switching into an off state, and to trigger the other switch to switch off after a fixed delay. Alternatively, a controller could be programmed to internally control this process without there being any need to actually detect the change in state of the switches. This control can be contained in the control circuitry 208, and the time interval, α, can be varied by a user or according to a lookup table.

In this way the second event is independent of a converter variable; the delay α being set independently from operational variables of the converter (e.g.: voltage or current based variables), and the second event being the conclusion of the delay.

The second switching event may alternatively be the expiration of a time interval that runs from a change of state of the same switch, or a clock signal could be used to trigger the switches to switch off, irrespective of the state of the other switch.

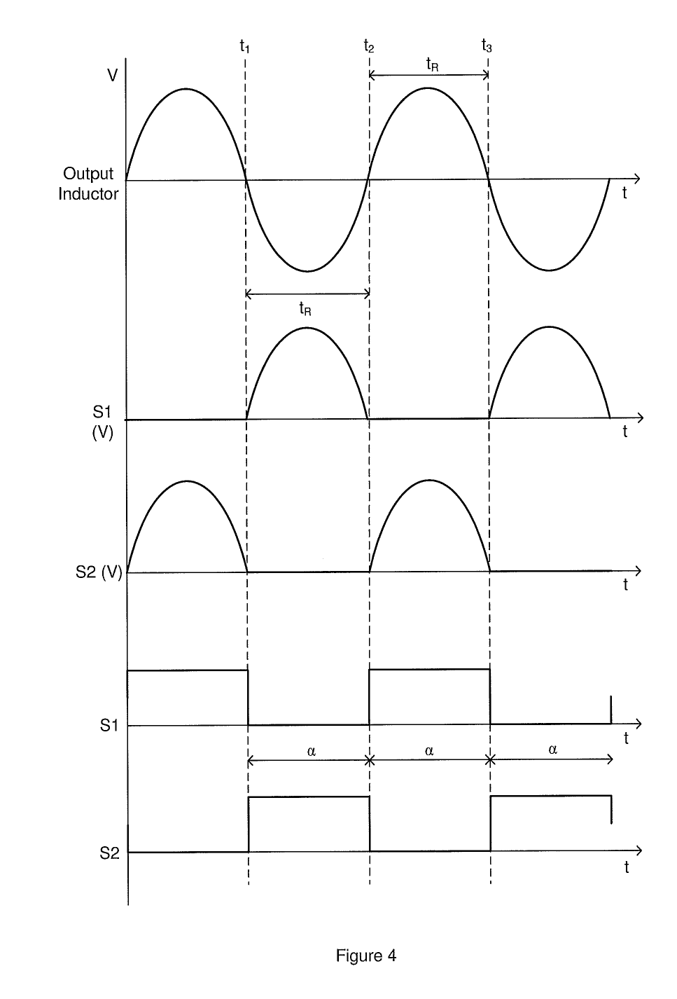

FIG. 4 shows the state of switch one and switch two, the voltage across each switch and the voltage across the output inductor. At time t₁, switch one switches off and switch two switches on. Switch two switches on because the voltage across the switch goes to zero. As switch one is switched off, the voltage across the inductor begins to increase then decrease (resulting in the observed waveform). After time α has elapsed since switch one switched off, at time t₂, switch two switches off. Since a has been preset to equate to half the natural resonant period (t_{R}) of the output inductor and output capacitor, t₂ corresponds to the time when the voltage across switch one goes to zero, and thus switch one switches on. This cycle repeats and results in a switching pattern that has the same effect as the 50% duty cycle with fixed frequency described earlier.

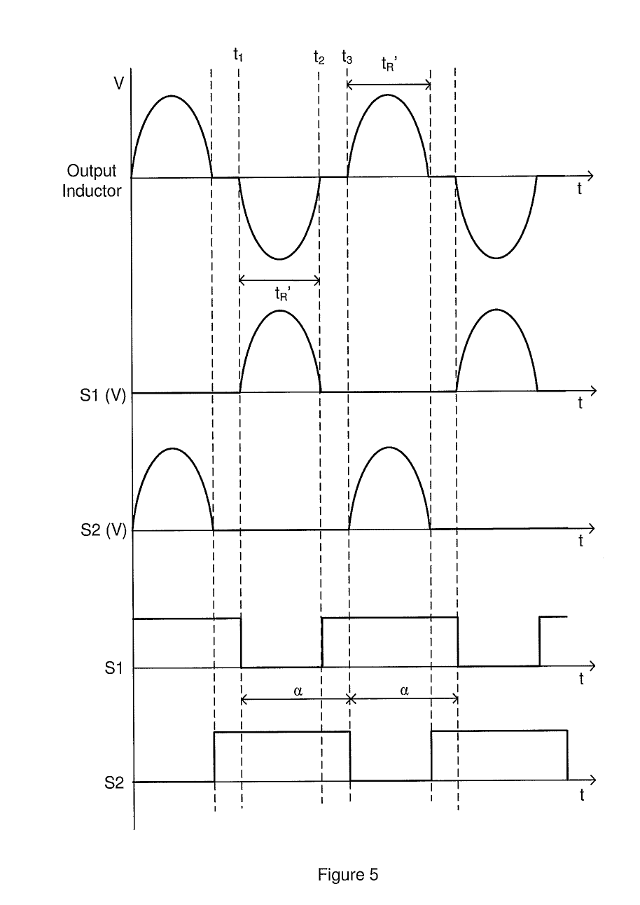

In some cases the resonant frequency of the output inductor and output capacitor may change e.g.: due to degradation of circuit parts; load changes affecting the coupling between the primary and secondary coils in IPT systems; etc. FIG. 5 illustrates where half the resonant time period (t_{R}′) is less than α, or where a is fixed to a value more than t_{R}′. At time t₁, switch one switches off, causing the voltage across the inductor to increase then decrease resulting in the observed waveform. Since t_{R}′ is less than α, the voltage across switch one reaches zero before a has elapsed. Hence, at t₂ switch one switches on. This occurs before switch two has switched off, so that both switches are simultaneously on. Then at t₃, after time α has elapsed since switch one switched off, switch two switches off. This cycle repeats and results in a switching pattern with a duty cycle greater than 50%, but with the same frequency as the example shown in FIG. 3 (i.e. 1/(2α)).

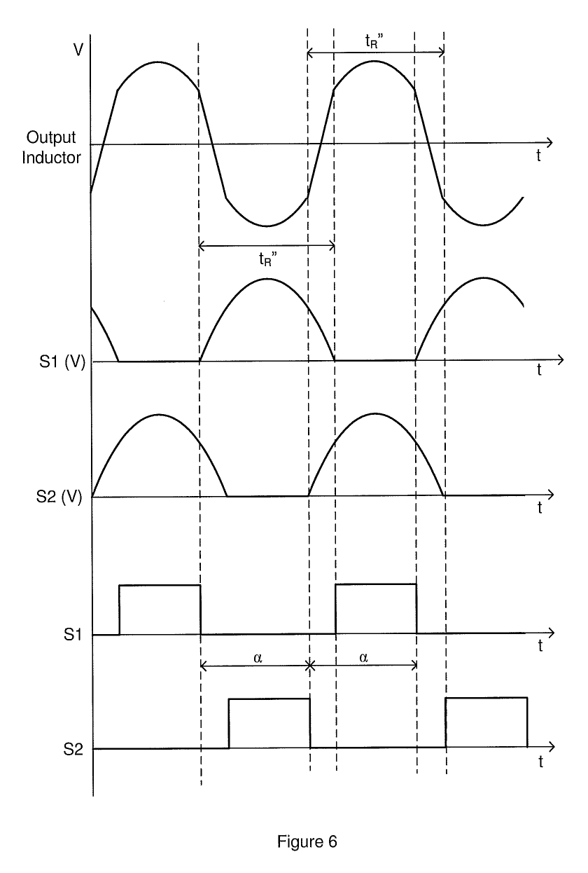

FIG. 6 demonstrates where t_{R}″ is more than α (or equivalently, where a is set to less than t_{R}″). In this embodiment, rather than both switches being simultaneously on for a portion of each cycle (as with the example given in FIG. 4), both switches are simultaneously off.

To avoid a high voltage spike from developing across open switch one 206 or open switch two 207 due to the energy stored in the inductors 203 a large snubber network may be used. For example additional discrete capacitors can be provided across each of switch one 206 and switch two 207 as snubbers, as well as forming part of the resonating network together with the output inductor 204.

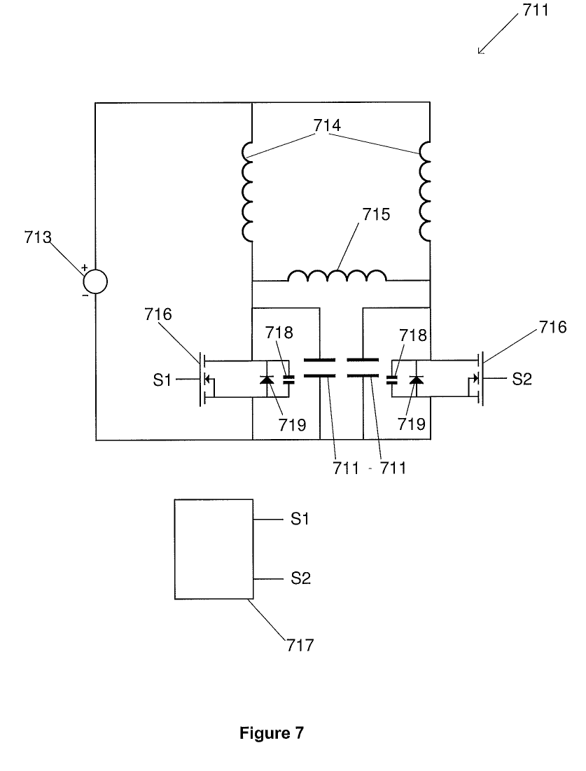

FIG. 7 shows such an alternative converter topology 711, which includes such additional capacitors 712. The converter 711 includes a DC supply 713, DC inductors 714, an output inductor 715, control switches 716 with parasitic capacitors 718 and parasitic body diodes 719, and control circuitry 717.

In an alternative embodiment, it may be desirable to prevent the waveforms as shown in FIG. 6 from occurring (for example, because a snubber network is not desirable). This can be achieved by controlling a to be not less than t_{R}″, or to use another methodology in those circumstances.

For example, it is possible to adjust the control method so that the switches are switched off when the last of the following occurs:
the expiration of a fixed time interval (α) after the other switch has switched off (i.e. the second switching event as described above); or
The other switch switching on.

Thus, the waveforms shown in FIG. 6 would not eventuate as each switch would switch off only when the other switch switches on; preventing both switches being simultaneously off. This results in a fixed frequency whenever the resonant period is less than or equal to 2α (i.e. 1/(2α)) but would have a variable frequency whenever the resonant period is greater than 2α.

One or more embodiments allow the frequency to remain fixed (as determined by α), whilst still being responsive to parameter variations such as changes in inductance and capacitance values, and changes in the load or coupling (by the duty cycle of the switches changing).

In prior art IPT systems an increase in load on the output of the receiver will cause the resonant frequency of the transmitting inductor (i.e. coil or coils) and capacitor to increase. However, the one or more embodiments ensure that the operating frequency of the transmitter remains constant (as determined by α). This can be demonstrated by comparing FIGS. 4 and 5.

If, for example, α is set to t_{R} under a first load, the waveform in FIG. 4 results. However, if there is an increase in load on the output of the receiver, the resonant frequency of the transmitting coil and capacitor will increase, which is equivalent to half the resonant period decreasing (i.e. t_{R}′, where t_{R}′<t_{R}). Since t_{R}′ is less than α, the waveforms in FIG. 5 result. The frequency of the transmitter remains constant despite load changes affecting the resonant frequency of the transmitting coil and capacitor. One or more embodiments may be able to adapt essentially immediately to changes in the load without requiring complicated control circuitry.

A further benefit in the context of IPT systems may be that a receiver does not need to retune if the transmitter frequency is constant. A receiver can thus be tuned to a set frequency, which may result in more efficient wireless energy transfer.

### Receiver

The method of controlling the inverter 6, described above, may also be adapted for use in the receiving circuitry 10. Typically receiving circuitry 10 includes a power pick-up stage, a rectification stage, and a power control stage.

In prior art receivers, losses in the receiving circuitry 10 may be problematic. For example the power control stage consists of some switching arrangement that contributes to loss. The rectifier stage adds to loss because of diode conduction losses, although this can be reduced by using a synchronous rectifier. Depending on the application the amount of power transferred to the receiver may already be low, e.g., of the order of a few to tens of Watts, therefore it may be desirable to reduce any loss in the receiving circuitry 10.

Where thermal considerations are also a design factor, this may increase the desirability to minimise receiver losses. It may also be desirable to reduce the component count, where the PCB size is important.

In a further embodiment an output power control stage is combined with a rectifier stage and/or a power pickup stage. In this way losses and circuit size may be minimised.

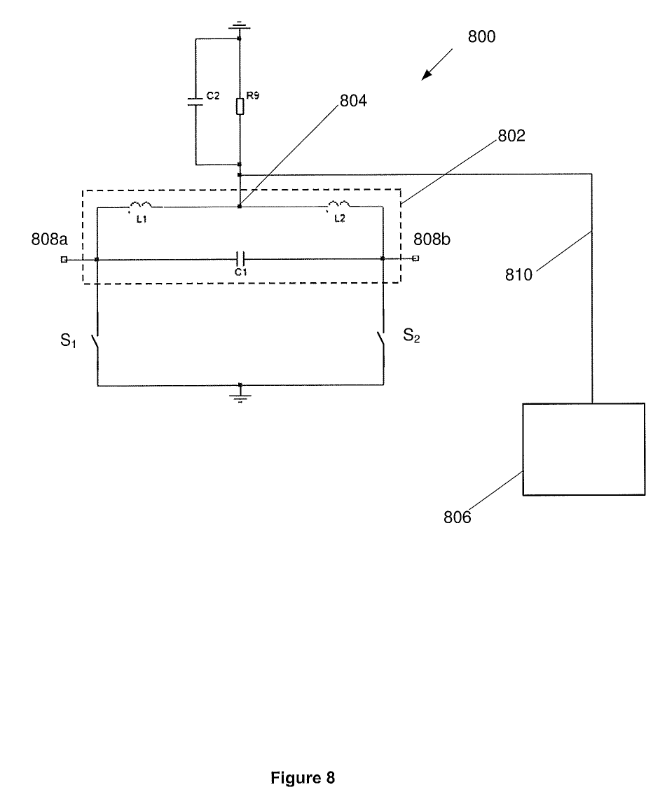

FIG. 8 shows a receiving circuitry topology 800 according to an embodiment which is applicable as power rectification and regulation circuitry of the receiver 3. A split receiver coil L₁ L₂ is connected in parallel with a tuning capacitor C₁. The combination of the coils L₁ L₂ and the capacitor C₁ form a resonant tank 802 which is tuned for a frequency substantially similar to that of the transmitter 2. The split receiver coils L₁ L₂ together act as the receiving coil 9, however this is achieved by ensuring that the level of mutual coupling between the coils L₁ and L₂ is minimised so that receipt of power transferred by the transmitter of the IPT system utilising the receiver is optimised. Ideally there is no mutual coupling, but in practice mutual coupling of up to about 30% is tolerable for the power receipt efficiency requisite in a commercial IPT system. This may be achieved by winding the coils L₁ and L₂ in the opposite sense, e.g., L₁ is wound clockwise and L₂ is wound counter-clockwise. Further, efficiency of the receiving coil(s) may be enhanced by winding or locating the coils on a mutual core, e.g., of magnetically permeable material, such as ferrite, to provide control of the magnetic fields induced therein.

The approximate mid-point or substantially centre tapping 804 of the coils L₁ L₂ is connected to load R₉ connected in parallel with a DC smoothing capacitor C₂. The ends of the coils L₁ L₂ are connected to two switches S₁ S₂ in a push pull or current doubling rectifier configuration. Each switch is provided with a control signal by a controller 806 to rectify the resonant voltage induced across the resonant tank 802 to that required by the load 11 (R₉) of the receiver 3. In particular, the voltage 808a 808b respectively at the resonant circuit of either coil L₁ L₂ and the output voltage 810 (with associated phase) from the resonant tank 802 are input to the controller 806 which compares these outputs so as to provide the control signals.

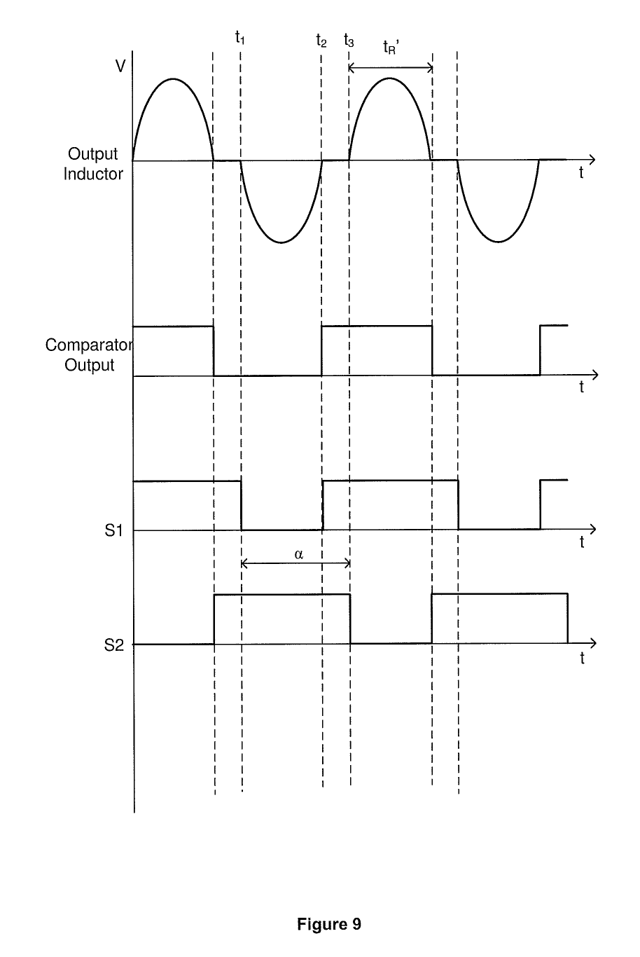

FIG. 9 shows an example of the control signals in the receiver. In summary each switch is switched similar to the afore-described switching of the inverter 6 in the transmitter 2. That is, each switch is turned ON based on a first event and turned OFF based on a second event.

Each switch is associated with one side of the voltage across the receiver coil(s). Typically in synchronous rectification, a switch is turned ON when the opposite side of the coil voltage begins to rise. In one embodiment a delay is inserted between the opposite coil voltage rise time and the switch ON time. In effect, the switches are used to ‘hold’ the voltage across the coil at 0V for a period of time. By adjusting the period of time during which the coil voltage is held at 0V, the DC output of the receiving circuitry 800 can be controlled to be higher or lower than the otherwise synchronously rectified DC output voltage. This means that the receiver 3 has buck and boost capability.

In other words, when the voltage on one side of the resonant tuning capacitor C₁ falls to zero, the corresponding switch on that side turns ON (first event), and remains on for the duration of half of a resonant cycle (when the voltage on the side of the resonant capacitor falls to zero), and holds ON for a set delay α thereafter (second event; which is the conclusion of the delay).

Similar to the control of the transmitter 2, in the receiver 3 the first event is dependent on a variable of the receiver itself e.g.: the receiver variable is the voltage zero crossing, and the second event is independent of a variable of the receiver, e.g., the delay α is set independently of operational variables of the receiver, such as voltage or current based variables, such that the second event sets the conclusion of the delay.

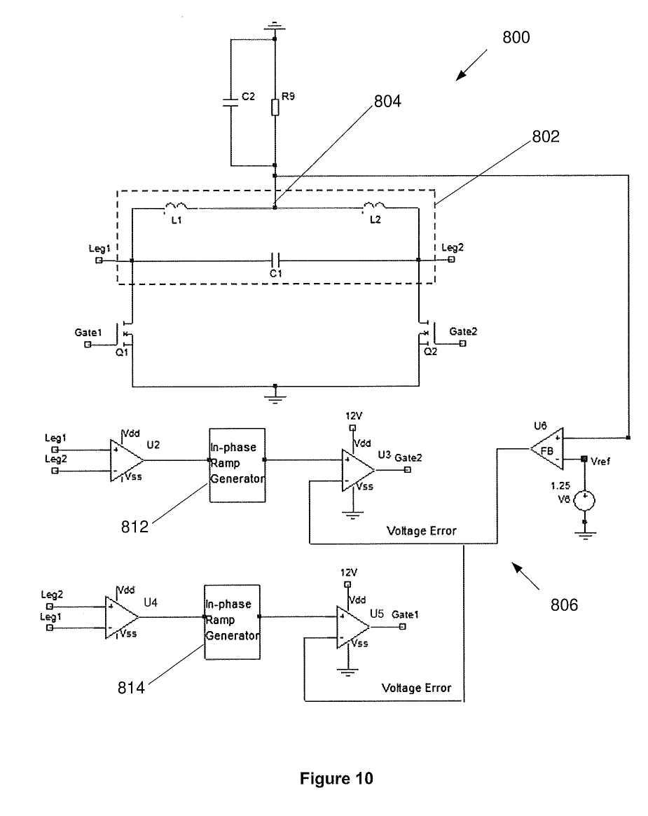

The controller 806 can be implemented using discrete analogue components (opamps, comparators, etc.) for a fixed output voltage and the switches can be implemented as field effect transistors Q₁ Q₂ (or other similar switch configurations), as shown in FIG. 10. In the exemplary embodiment depicted in FIG. 10, the voltage across the resonant tank 802 is measured by comparator U₂. The square wave output is provided to a ramp generator 812. The DC output voltage is converted to an error signal which compares it to a 1.25V DC signal. The ramp voltage is compared by comparator U₃ to the DC error signal, and the output is provided to the gate of Q₂. Similarly the opposite polarity of the voltage across the resonant tank 802 is measured by comparator U₄. Ramp generator 814 and comparator U₄ generate the gate signal for Q₁. In this fashion closed loop control can be achieved to maintain the output DC voltage at a predetermined value according to the V_{ref} signal. In effect the delay α is adjusted until the output voltage is 1.25V. This is because the output voltage at the output phase is fed straight into U₆. Alternatively the target output voltage could be set by feeding a fraction of the output voltage into U₆ (through a voltage divider). For example, to regulate the output at 2.5V, the output voltage could be divided by 2 and that signal fed into U₆ with the 1.25V_{ref}.

Alternatively the controller can be implemented with a microcontroller for an adjustable output voltage. In one example, the output voltage may be sensed and then the delay α can be increased or decreased in steps by a microcontroller to vary the output in a closed feedback loop. The algorithm steps may be programmed into the microcontroller to include predetermined criteria relating to the control strategy.

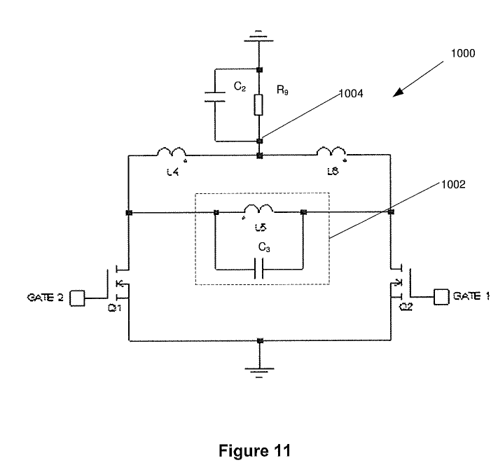

In a further embodiment, receiver circuitry 1000 shown in FIG. 11 is provided in which the receiver circuitry 1000 has a single (loop) coil L₅ which is connected in parallel to a tuning capacitor C₃ to form a resonant tank 1002. Two (split) DC inductors L₄ L₈ connect the resonant tank 1002 to a DC voltage output node 1004 connected to (DC) load R₉ (11) of the receiver 3 shown in parallel with a smoothing capacitor C₂. As with FIG. 8, two switches Q₁ Q₂ are connected in a push pull or current doubling rectifier configuration to the resonant tank 1002 and are operated in the same manner.

The circuit in FIG. 10 may be more useful than the circuit of FIG. 11 in situations where a fixed coupling coefficient between transmit and receive coils is present, or when circuit size and complexity is a priority over output voltage ripple, for example. This is because the circuit in FIG. 11 contains large DC inductors. These inductors provide stability for the system and act to smooth the DC output current such that the DC output ripple may be lower with this configuration but the circuit size is larger as compared with the FIG. 10 embodiment. Also a conventional single inductor receiver coil can be utilized so the manufacture of the receiver coil may be simpler and cheaper.

While the present invention has been illustrated by the description of the embodiments thereof, and while the embodiments have been described in detail, it is not the intention of the Applicant to restrict or in any way limit the scope of the appended claims to such detail. Additional advantages and modifications will readily appear to those skilled in the art. Therefore, the invention in its broader aspects is not limited to the specific details, representative apparatus and method, and illustrative examples shown and described. Accordingly, departures may be made from such details without departure from the spirit or scope of the Applicant's general inventive concept.

1. An inductive power receiver including at least two switches connected across a resonant circuit, the resonant circuit including an inductance and a capacitance, wherein:
a first switch of the at least two switches is configured to switch into a first state based on a first event dependent on a receiver variable; and
the first switch is configured to switch to a second state based on a second event independent of a receiver variable.

2. The receiver in claim 1, wherein the first event is the voltage across or current in the first switch reaching, crossing through, or rising from zero.

3. The receiver in claim 2, wherein the second event is the conclusion of a delay.

4. The receiver in claim 3, wherein the delay starts from when a second switch of the at least two switches, switches to the second state.

5. The receiver in claim 3, wherein the delay is determined based on a predetermined DC output voltage.

6. The receiver in claim 5 where the predetermined DC output voltage is selected from the group consisting of a buck voltage and a boost voltage.

7. The receiver in claim 3, wherein the delay is determined based on predetermined criteria.

8. The receiver in claim 3, further comprising a closed loop controller configured to provide switching signals to the at least two switches, to control the DC output voltage to a substantially predetermined level.

9. The receiver in claim 1 wherein the resonant circuit includes a pair of receiving coils in series or a split receiving coil, in parallel with a capacitor, and wherein a common point between the coils is connected to a DC load.

10. The receiver in claim 1 wherein the resonant circuit includes a receiving coil in parallel with a capacitor, and the receiver further comprises two inductors, each connected between a respective switch and a DC load.

11. The receiver in claim 1 wherein the combination of the at least two switches connected across a resonant circuit is a modified push pull converter or modified current doubling rectifier circuit.

12. The receiver in claim 1 wherein the first state is an ON state and the second state is an OFF state.
